(19) United States
(12) Patent Application Publication
(10) Pub. No.: US 2015/0058256 A1
(43) Pub. Date: Feb. 26, 2015

(54) Portfolio Optimization by Reduction of Chaotic Intermittency

(71) Applicant: Edgar Parker, JR., Elmont, NY (US)

(72) Inventor: Edgar Parker, JR., Elmont, NY (US)

(21) Appl. No.: 14/010,505

(22) Filed: Aug. 26, 2013

(51) Int. Cl. G06Q 40/06

(52) U.S. Cl. CPC G06Q 40/06
USPC 705/36 R

(57) ABSTRACT

An investment portfolio management method for creating or rebalancing an investor's securities portfolio based on reducing, completely eliminating, increasing, or maximizing the relative proportion or number of investments that are determined to have an underlying intermittently chaotic nonlinear generating mechanism within the portfolio. The presence of chaos or chaotic traits and intermittent chaos can be indicated by a subset of a group of statistical and mathematical tests of mathematical and statistical chaos. The method utilizes existing statistical tests and mathematical tests chaotic structure in time series combined with the new theory of chaotic portfolio optimization as developed by the inventor. By eliminating or altering the relative intermittently chaotic proportion of investments a portfolio can be optimized by taking advantage of additional information implied by chaotic traits that are not utilized by other methods. This allows the maximization of the portfolio's expected return and the minimization of its risk.

### RELATED APPLICATIONS

The present application claims the benefit under 35 U.S.C. .sctn. 119(e) of U.S. Provisional Application Ser. No. 61/693,393, filed Aug. 27, 2012, entitled “ Portfolio Optimization by Reduction of Chaotic Intermittency,” which is incorporated herein by reference in its entirety.

### SPECIFICATION

An investment portfolio management method for creating or rebalancing an investor's securities portfolio based on reducing, completely eliminating, increasing, or maximizing the relative proportion or number of investments that are determined to have an underlying intermittently chaotic nonlinear generating mechanism within the portfolio. The presence of chaos or chaotic traits and intermittent chaos can be indicated by a subset of a group of statistical and mathematical tests of mathematical and statistical chaos. The method utilizes existing statistical tests and mathematical tests or descriptions of chaotic structure in time series combined with the new theory of chaotic portfolio optimization as developed by the inventor.

The method's goal is to maximize a portfolio's expected return while minimizing the portfolio's risk. By eliminating, reducing, or altering the relative intermittently chaotic proportion of investments a portfolio can be optimized by taking advantage of additional information implied by chaotic traits that are not utilized by other methods. This additional information will allow the maximization of the portfolio's expected return and the minimization of its risk. Conversely there are circumstances when a single security or investment or a portfolio with maximal risk or volatility is desired (Such as investments in some derivative options). Increasing or maximizing the relative intermittently chaotic proportion of securities or investments in a portfolio can increase the overall volatility of the portfolio. Similarly by selecting single securities or single investments with evidence of intermittently chaotic structure, selections can be made with resulting higher levels of volatility than by using more traditional methods. Existing portfolios can be optimized using this technique individually or in conjunction with other teclufiques such as Modern Portfolio Theory (MPT). Additionally this technique can be utilized to completely and independently construct a minimally or mixed chaotic portfolio without also using other techniques.

Tests of Chaaos and Intermittency used in the Steps that follow:
1. PRST (Estimating Fractal dimension, Largest Lyapunov Exponent, and the Kolmogorov Entropy) as described by (Rosenstein et al. 1993)
2. Correlation Dimension
3. Grassberger-Procaccia algorithm (GPA) for dimension and entropy
4. BDS Tests as described by (Brock et al. 1993)
5. Kolmogorov entropy
6. Barahona/Poon
7. Nychka, Ellner, Gallant, and McCaffrey (1992) dominant Lyapunov exponent estimator.
8. Visualization of system dynamics using phasegrams by Christian T. Herbst, Hanspeter Herzel, Jan G. Svec, Megan T. Wyman and W. Tecumseh Fitch (May 2013).

The invention claimed is:

1. A method of portfolio management comprising:
receiving at a computer of an investor a portfolio of investments or securities with historical market price data;
responsive to the receipt of said portfolio of investments or securities with corresponding historical market price data, said computer conducting tests of indications of the existence and degree of chaotic structure on the individual investments or securities;
generating the group of investments or securities to include in the new portfolio based upon selecting individual investments or securities from said original portfolio for exclusion in the final portfolio on the basis positive results of the mathematical and statistical tests for the presence of chaos and chaotic indicators in the historical market price data in the corresponding investment or security.

2. A method of portfolio management comprising:
receiving at a computer of an investor a portfolio of investments or securities with historical market price data;
responsive to the receipt of said portfolio of investments or securities with corresponding historical market price data, said computer conducting tests of indications of the existence and degree of intermittent chaotic structure on the individual investments or securities;
generating the group of investments or securities to include in the new portfolio based upon selecting individual investments or securities from said original portfolio for exclusion in the final portfolio on the basis positive results of the mathematical and statistical tests for the presence of intermittent chaos and intermittent chaotic indicators in the historical market price data in the corresponding investment or security.

3. A method of portfolio management comprising:
receiving at a computer server from at least one client system associated with an investor a portfolio of investments or securities with historical market price data;
responsive to the receipt of said portfolio of investments or securities with corresponding historical market price data, said computer conducting tests of indications of the existence and degree of chaotic structure on the individual investments or securities;
generating the group of investments or securities to include in the new portfolio based upon selecting individual investments or securities from said original portfolio for exclusion in the final portfolio on the basis positive results of the mathematical and statistical tests for the presence of chaos and chaotic indicators in the historical market price data in the corresponding investment or security.

4. A method of portfolio management comprising:
receiving at a computer server from at least one client system associated with an investor a portfolio of investments or securities with historical market price data;
responsive to the receipt of said portfolio of investments or securities with corresponding historical market price data, said computer conducting tests of indications of the existence and degree of intermittent chaotic structure on the individual investments or securities;
generating the group of investments or securities to include in the new portfolio based upon selecting individual investments or securities from said original portfolio for exclusion in the final portfolio on the basis positive results of the mathematical and statistical tests for the presence of intermittent chaos and intermittent chaotic indicators in the historical market price data in the corresponding investment or security.

5. A method of portfolio management comprising:
receiving at a computer of an investor a portfolio of investments or securities with historical market price data;
responsive to the receipt of said portfolio of investments or securities with corresponding historical market price data, said computer conducting tests of indications of the existence and degree of chaotic structure on the individual investments or securities;
generating the group of investments or securities to include in the new portfolio based upon selecting individual investments or securities from said original portfolio for inclusion in the final portfolio on the basis positive results of the mathematical and statistical tests for the presence of chaos and chaotic indicators in the historical market price data in the corresponding investment or security.

6. A method of portfolio management comprising:
receiving at a computer of an investor a portfolio of investments or securities with historical market price data;
responsive to the receipt of said portfolio of investments or securities with corresponding historical market price data, said computer conducting tests of indications of the existence and degree of intermittent chaotic structure on the individual investments or securities;
generating the group of investments or securities to include in the new portfolio based upon selecting individual investments or securities from said original portfolio for inclusion in the final portfolio on the basis positive results of the mathematical and statistical tests for the presence of intermittent chaos and intermittent chaotic indicators in the historical market price data in the corresponding investment or security.

7. A method of portfolio management comprising:
receiving at a computer server from at least one client system associated with an investor a portfolio of investments or securities with historical market price data;
responsive to the receipt of said portfolio of investments or securities with corresponding historical market price data, said computer conducting tests of indications of the existence and degree of chaotic structure on the individual investments or securities;
generating the group of investments or securities to include in the new portfolio based upon selecting individual investments or securities from said original portfolio for inclusion in the final portfolio on the basis positive results of the mathematical and statistical tests for the presence of chaos and chaotic indicators in the historical market price data in the corresponding investment or security.

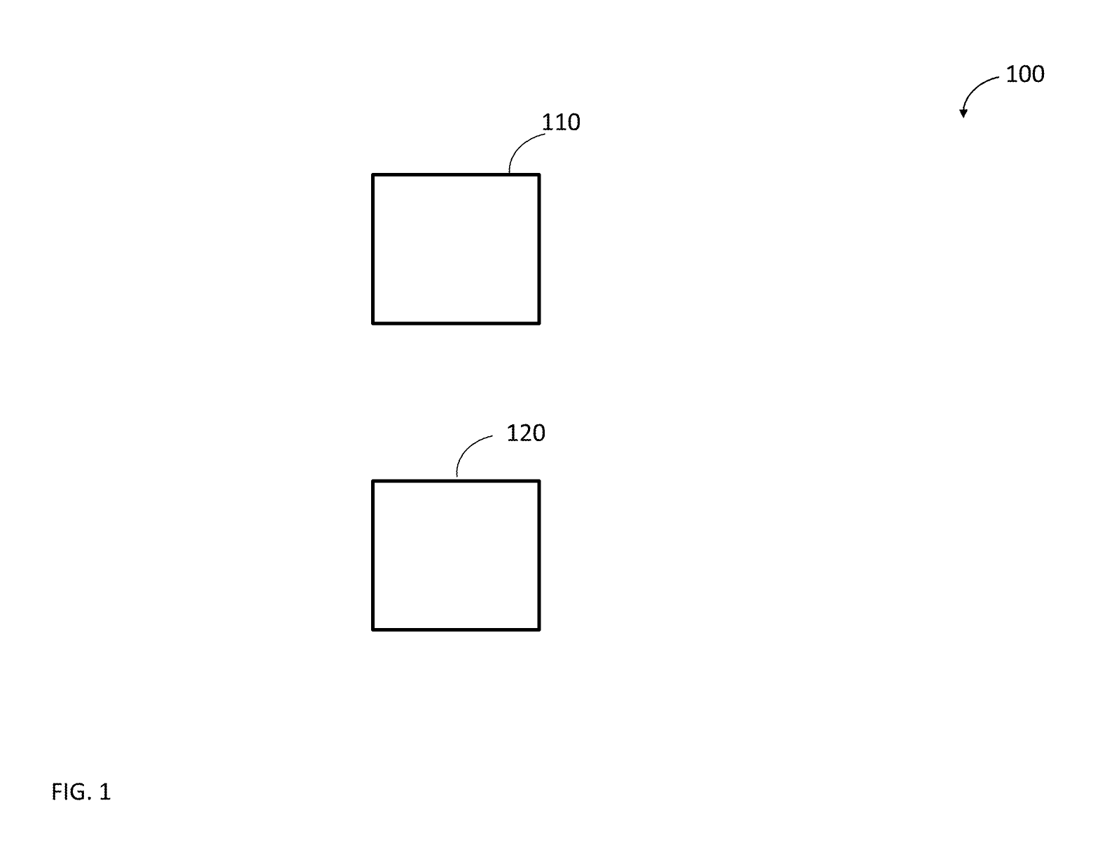

8. A method of portfolio management comprising:
receiving at a computer server from at least one client system associated with an investor a portfolio of investments or securities with historical market price data;
responsive to the receipt of said portfolio of investments or securities with corresponding historical market price data, said computer conducting tests of indications of the existence and degree of intermittent chaotic structure on the individual investments or securities;
generating the group of investments or securities to include in the new portfolio based upon selecting individual investments or securities from said original portfolio for inclusion in the final portfolio on the basis positive results of the mathematical and statistical tests for the presence of intermittent chaos and intermittent chaotic indicators in the historical market price data in the corresponding investment or security.
Steps for claims 1 and 3:
1. A subset of but not limited to the above tests for chaos and descriptions of chaotic behavior are conducted on the historical values of the individual securities or investments in a portfolio.
2. Those securities or investments deemed to have a chaotic underlying generating structure are excluded from the portfolio.
3. The portfolio can be rebalanced using the traditional techniques of Modem Portfolio Theory.
Steps for claims 2 and 4:
1. A subset of but not limited to the above tests for chaos and descriptions of chaotic behavior are conducted on the historical values of the individual securities or investments in a portfolio.
2. Those securities or investments deemed to exhibit the presence of intermittent chaos and intermittent chaotic indicators are excluded from the portfolio.
3. The portfolio can be rebalanced using the traditional techniques of Modem Portfolio Theory.
Steps for claims 5 and 7:
1. A subset of but not limited to the above tests for chaos and descriptions of chaotic behavior are conducted on the historical values of the individual securities or investments in a portfolio.
2. Those securities or investments deemed to have a chaotic underlying generating structure are included in the portfolio, or a single security or investment is selected with the maximized desired volatility.
3. The portfolio can be rebalanced as desired.
Steps for claims 6 and 8:
1. A subset of but not limited to the above tests for chaos and descriptions of chaotic behavior are conducted on the historical values of the individual securities or investments in a portfolio.
2. Those securities or investments deemed to exhibit the presence of intermittent chaos and intermittent chaotic indicators are included in the portfolio, or a single security or investment is selected with the maximized desired volatility.
3. The portfolio can be rebalanced as desired.
DETAILED DESCRIPTION OF THE EXEMPLARY EMBODIMENTS
FIG. 1 depicts an operating environment 100 in accordance with an exemplary embodiment of the present invention. Referring to FIG. 1, a computer 110 or server 120 hosts software used to identify chaotic and intermittently chaotic securities for inclusion or exclusion in a portfolio.
